(19) United States
(12) Patent Application Publication
(10) Pub. No.: US 2004/0067794 A1
(43) Pub. Date: Apr. 8, 2004

(54) Gambling on real gaming machines over the internet

(76) Inventor: Jacobus Marthinus Johannes Coetzee, Welkom (ZA)

Correspondence Address: Robert J. Sacco, Akerman Senterfitt, P.O. Box 3188, West Palm Beach, FL, 33402-3188, US

(21) Appl. No.: 10/263,039

(22) Filed: Oct. 2, 2002

(51) Int. Cl. G06F 17/00

(52) U.S. Cl. 463/42

(57) ABSTRACT

The invention provides a gaming system including a gaming venue having one or more gaming machines and/or gaming tables, remotely actuatable initiation means for initiating said machines and/or tables from a remote location to accept a stake and to carry out the normal functions associated with said machines and/or tables once a stake has been accepted thereby to produce an outcome for the gambler, and a substantially real time image capturing and transmission means for capturing and transmitting the images of said machines and/or tables over the internet for at least part of the time from when the stake is accepted to when there is the outcome.

This invention relates to gambling on real gaming machines over the internet.

The inventor is aware that presently, in order to gamble on real gaming machines, such as poker machines or so called fruit machines (also called one arm bandits colloquially), or on real gaming tables a gambler is obliged to attend at a casino or other premises where such machines or tables may be found.

The inventor is further aware that internet gaming where a mathematical model or an empirical model simulation of a gaming machine or a gaming table is provided on a remote server and gamers play these simulated machines and/or tables at their computers or other internet terminals.

The inventor is also aware of U.S. Pat. No. 6,001,016 to Walker, in which patent is disclosed a method and system for remote play of a slot machine. A player enters play preferences at a remote wagering terminal. The remote wagering terminal transmits the play preferences to a slot network server that stores the play preferences. Based upon the play preferences, the slot network server identifies one or more slot machines and transmits outcome data from those slot machines to the remote wagering terminal. The outcome data may be live or historical. In one embodiment the slot network server generates visual representation data based on the historical data, and transmits same to the remote wagering terminal. The slot network server keeps track of the player's wins and losses based upon the outcome data. This system however does not have the feel and atmosphere of live gambling at a slot machine or a roulette table as the player merely sees a simulated display thereof on his terminal rather than the actual live action.

The draw back of each of the above is that in order to have the realism and feel of playing physical machines or tables with real world variances and influences that these exhibit a gambler must leave his home whereas if the gambler wishes to gamble from home then he must be satisfied with the simulation and the lack of realism that this entails.

Thus, according to a first aspect of the invention, there is provided a gaming system including:

a gaming venue having one or more gaming machines and/or gaming tables;

remotely actuatable initiation means for initiating said machines and/or tables from a remote location to accept a stake and to carry out the normal functions associated with said machines and/or tables once a stake has been accepted thereby to produce an outcome for the gambler; and

a substantially real time image capturing and transmission means for capturing and transmitting the images of said machines and/or tables over the internet for at least part of the time from when the stake is accepted to when there is the outcome.

When referring to the internet in this specification, this is meant to include Digital Interactive Television, Internet TV, Web TV, and any other means of accessing the internet besides the standard method of using a personal computer or a mobile terminal. In particular the technology of WAP mobile phones is included in the scope of this invention.

The system may include processing of gaming credits and debits from an account accessible over the internet. Said account may be a credit or debit card account such as those commonly used in e-commerce.

The system may include a gaming account with the gaming venue which is credited and debited in accordance with the stake accepted and the outcome of the gaming event. The debits and credits of the gaming account may be transferable electronically to an outside banking account.

The gaming venue may be a conventional casino gaming hall. Typically however the gaming venue will be a separate room or hall wherein at least some of said machines or some places at said tables are reserved for the internet gaming system and may only be played by gamers over the internet. Usually said machines and tables will be in a separate room with no access to the public or gamers except via the internet. This permits a higher density of said machines and/or tables per unit floor area of the venue.

Said gaming machines may be the highest paying machines in the casino, for example, the million rand jackpot machines of the Sun International group. Said gaming machines of various casinos may be linked to enhance the jackpot.

The system may include a server accessible over the internet from terminals having access to the internet. The server may include security safeguards such as encryption, password protected access, age verification, firewalls, and the like.

The remotely actuatable initiation means may be in the form of an electrical connection to an initiation circuit of said machines or tables. The initiation circuit could connect to or be part of the circuit currently used by the lever arm or actuation button of said machines. In the case of gaming tables, the initiation circuit could include a number of lights or a text display instructing the table operator to place a bet on behalf of the gamer and then to deal a card, spin a wheel, roll a dice, or the like.

The remotely actuatable initiation means may be a motor opertaivley connected to the lever arm of a slot machine thereby to carry out the pulling action normally carried out by a player when playing the machine.

The outcome in the case of gaming tables may be identified and transmitted automatically without the table operator's intercession. Typically this may be done by using sensors located in the gaming tables the outputs of which are transmitted to a computer which declares an outcome which is then transmitted to the player over the internet.

The sensors mentioned above may include proximity switches, pressure switches, light or laser position identifying means, for example in the form of a grid of beams, and the like.

The remotely actuatable initiation means may be operated over the internet from a computer by using a pointing device such as a mouse, a keyboard, or other similar computer interface device. In one embodiment the gamer points the mouse pointer at a machine on which a stake is to be placed and by clicking the mouse button the bet is accepted and the machine performs its normal gaming functions.

The substantially real time image capturing and transmission means could be in the form of a digital video camera linked to a computer which is linked to the internet and transmits the images in substantially real time, for example, as streaming video via a protocol such as Real Player™. This is commonly referred to as using a WebCam™ or a Vivo Cam™. The digital video camera could be in the form of an analogue video camera with an analogue to digital converter.

The system may include translocation means for the real time imaging and transmission means. The translocation means may include a robot carrying said camera, a rail along which said camera is displaced the rail being routed through the venue along a desired path, a boom on which the camera is mounted and which may be activated to translocate the camera along a desired path, or any suitable translocation means capable of achieving the aforementioned.

The translocation means may enable a gamer to take a virtual walk through the venue before selecting a particular machine or table to game at, thereby enhancing the feeling of being there in the venue.

The translocation means may be operated over the internet from a computer by using a pointing device such as a mouse, a keyboard, or other similar computer interface device. In one embodiment the gamer points the mouse pointer at a machine on which he wishes to place a stake thereby translocating the camera towards the selected machine, if the machine is available i.e. it is not already in use and is in working order, by clicking the mouse button a bet may be paced and/or accepted and the machine performs its normal gaming functions.

A busy indicator may be provided on said machines or tables such that when a gamer views a machine or table the availability thereof is apparent.

Payment for use of the system by a gamer may be received in many various ways, for example, a periodic membership fee, use of encryption/decryption for members such as software or a dedicated console, an initial entry fee with each wager, or the like.

Typically, a gamer would apply for membership to the gaming venue and upon acceptance of the application, encryption software and/or a password would be provided to the gamer. The gamer would then log on to the server of the gaming venue by using the password and deposit or transfer an amount to be credited to the gaming account of the gamer. The gamer would then proceed to tender stakes for selected gaming machines and/or tables and upon acceptance of the stake by the server the selected gaming machine or table would be actuated to begin its normal gaming actions, for example, to spin the wheels or the deal a card or to roll a dice etc. Prior to accepting the stake the server would first check the status of the selected machine or table to ensure its operability and availability. The server would monitor the outcome of the gaming action and if the outcome was positive for the gamer, the gaming account would be credited with the amount won. The gamer could then at the gamer's instance choose to log out of the server or to tender a further stake on the same or different machine or table.

Gaming wagers may be made by credit card, deposit account, direct debit, eftpos, or the like. Suitable security measures, such as those known in the art, may be used to reduce the risk of theft and fraud.

The system may operate over an internet website.

The system may be operated from smaller casinos thereby to permit increasing of jackpot values by permitting a gamer to access the jackpot machines at another venue from the smaller casino.

The system may operate from a cafe type venue so that a gamer may go to the venue and gamble at various casinos over the system without going to each venue individually.

The invention is not limited to any specific internet protocol or data transfer technology and all variations falling within the spirit of the invention are included herein.

### DESCRIPTION OF AN EMBODIMENT OF THE INVENTION

The invention will now be illustrated, by way of non-limiting example only, with reference to the attached schematic representation. In the Figures,

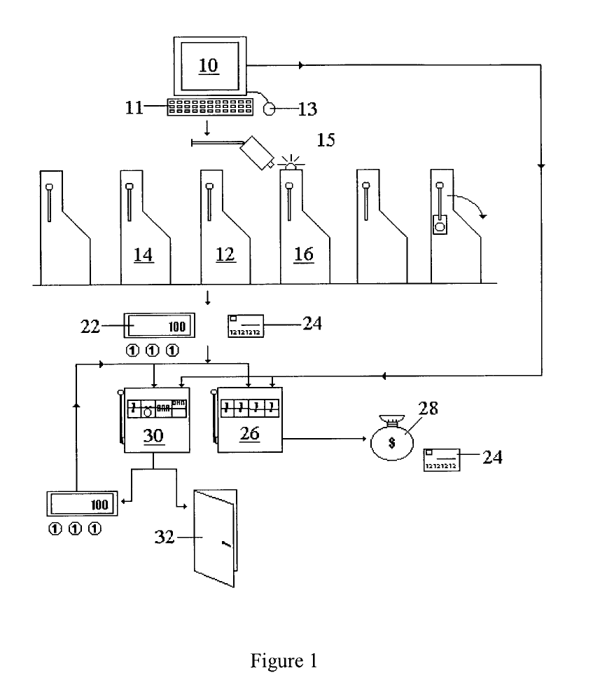

FIG. 1 shows a schematic representation of the operation of a system in accordance with the invention.

In FIG. 1, a gamer enters a password into a home computer 10 on which is running an internet browser such as Internet Explorer from Microsoft. The gamer then logs on to the server of the gaming venue by using the password and selects a machine 12 to play on after checking the status thereof for availability.

The selection of the machine 12 is facilitated by viewing machines 12, 14, 16 over the internet by means of the video camera 18 which is mounted on a displaceable boom 20. The image captured by the camera 18 is transmitted to the computer 10 where the gamer can see that machine 16 is unavailable because the light 15 is on.

Once the machine 12 has been selected, the gamer transfers an amount 22 to be credited to his gaming account by authorising a debit of his credit card 24. The gamer then proceeds to tender stakes for selected gaming machine 12 by using the keyboard 11 and mouse 13 of the computer 10, and upon acceptance of the stake by the server the selected gaming machine is actuated by an electric motor fitted to its lever arm to begin its normal gaming actions by spinning of its reels. Prior to accepting the stake the server first checks the status of the selected machine 12 to ensure its operability and availability.

The server and gamer monitor the outcome of the gaming action and if the outcome was positive 26 for the gamer, the gaming account would be credited with the amount won 28. The gamer could then at the gamer's instance choose to log out of the server or to tender a further stake on the same or different machine or table i.e. proceed from any point along the flow sheet without a further transfer of funds.

If the outcome is negative 30 for the gamer and he loses his stake the gamer may at his instance either place a further stake by transferring an amount 22 as explained above, or log out from the system 32.

1. A gaming system including:
a gaming venue having one or more gaming machines and/or gaming tables;
remotely actuatable initiation means for initiating said machines and/or tables from a remote location to accept a stake and to carry out the normal functions associated with said machines and/or tables once a stake has been accepted thereby to produce an outcome for the gambler; and
a substantially real time image capturing and transmission means for capturing and transmitting the images of said machines and/or tables over the internet for at least part of the time from when the stake is accepted to when there is the outcome.

2. A gaming system as claimed in claim 1, including processing of gaming credits and debits from a gaming account with the gaming venue which is credited and debited in accordance with the stake accepted and the outcome of the gaming event and which is accessible over the internet.

3. A gaming system as claimed in claim 1, wherein the gaming venue is a conventional casino gaming hall.

4. A gaming system as claimed in claim 1, wherein the gaming venue is a separate room or hall wherein at least some of said machines or some places at said tables are reserved for the internet gaming system and are only playable by gamers over the internet.

5. A gaming system as claimed in claim 4, wherein said machines and tables are in the separate room with no access to the public or gamers except via the internet thereby permitting a higher density of said machines and/or tables per unit floor area of the venue.

6. A gaming system as claimed in claim 1, including a server accessible over the internet from terminals having access to the internet, the server including security safeguards including at least one or more of encryption, password protected access, age verification, and a firewall.

7. A gaming system as claimed in claim 1, wherein the remotely actuatable initiation means is in the form of one or more of an electrical connection to an initiation circuit of said machines or tables and a drive means for actuating a lever of said machines.

8. A gaming system as claimed in claim 7, wherein in the case of gaming tables, the initiation circuit includes a number of lights or a text display instructing the table operator to place a bet on behalf of the gamer and then to carry out an action selected from the group including dealing a card, spinning a wheel, and rolling one or more dice.

9. A gaming system as claimed in claim 1, wherein the remotely actuatable initiation means is operated over the internet from a computer by using a pointing device.

10. A gaming system as claimed in claim 9, wherein the gamer points a pointer at a representation of a machine on which a stake is to be placed and places a bet whereafter the machine performs its normal gaming functions.

11. A gaming system as claimed in claim 1, wherein the substantially real time image capturing and transmission means includes at least a video camera linked to a computer which is linked to the internet and transmits the images in substantially real time.

12. A gaming system as claimed in claim 1, including translocation means for the real time image capturing and transmission means.

13. A gaming system as claimed in claim 12, wherein the translocation means includes one or more of a robot carrying said camera, a rail along which said camera is displaced the rail being routed through the venue along a desired path, and a boom on which the, camera is mounted and which may be activated to translocate the camera along a desired path.

14. A gaming system as claimed in claim 12, wherein the translocation means enables a gamer to take a virtual walk through the venue before selecting a particular machine or table to game at, thereby enhancing the feeling of being there in the venue.

15. A gaming system as claimed in claim 14, wherein the translocation means is operated over the internet from a computer by using a pointing device such as a mouse, a keyboard, or other similar computer interface device.

16. A gaming system as claimed in claim 15, wherein the gamer points a computer interface pointer device at a representation of a machine or table on which he wishes to place a stake thereby translocating the camera towards the selected machine, if the machine is available, by selecting the machine using said pointer device a bet is placed and/or accepted and the machine or table performs its normal gaming functions.

17. A gaming system as claimed in claim 16, wherein a busy indicator is provided on said machines or tables such that when a gamer views a machine or table the availability thereof is apparent.

18. A gaming system as claimed in claim 1, wherein payment for use of the system by a gamer is received in one or more ways selected from a periodic membership fee, use of encryption/decryption for members such as software or a dedicated console, and an initial entry fee with each wager.

19. A gaming system as claimed in claim 18, wherein a gamer applies for membership to the gaming venue and upon acceptance of the application, encryption software and/or a password are provided to the gamer permitting the gamer to log on to the server of the gaming venue by using the password and to deposit or transfer an amount to be credited to the gaming account of the gamer.

20. A gaming system as claimed in claim 19, wherein the gamer proceeds to tender stakes for selected gaming machines and/or tables and upon acceptance of the stake by the server the selected gaming machine or table would be actuated to begin its normal gaming actions.

21. A gaming system as claimed in claim 20, wherein prior to accepting the stake the server first checks the status of the selected machine or table to ensure its operability and availability.

22. A gaming system as claimed in claim 1, which is operated through a website on the internet.

23. A gaming system as claimed in claim 1, wherein in the case of gaming tables, in order to produce an outcome for the gambler, the outcome at the table is identified and transmitted automatically by using sensors located in the gaming tables the outputs of which are transmitted to a computer which declares an outcome which is then transmitted to the player over the internet.
